(19) United States
(12) Patent Application Publication
(10) Pub. No.: US 2008/0111960 A1
(43) Pub. Date: May 15, 2008

(54) Liquid Crystal Panel and Liquid Crystal Display Apparatus

(75) Inventors: Kentarou Yoshida, Osaka (JP); Nao Murakami, Osaka (JP); Hiroyuki Yoshimi, Osaka (JP); Yoshiyuki Kiya, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Ibaraki-shi, Osaka (JP)

(21) Appl. No.: 11/795,252

(22) PCT Filed: Dec. 19, 2005
(86) PCT No.: PCT/JP05/23252

§ 371 Date: Jul. 13, 2007

(51) Int. Cl. G02F 1/1335

(52) U.S. Cl. 349/117

(57) ABSTRACT

There are provided a liquid crystal panel and a liquid crystal display apparatus each having significantly improved color shift. The liquid crystal panel includes a backlight part emitting polarized light, an optical compensation layer, a first polarizer, a liquid crystal cell, and a second polarizer in the stated order from a backlight side.

### TECHNICAL FIELD

The present invention relates to a liquid crystal panel and to a liquid crystal display apparatus. In particular, the present invention relates to a liquid crystal panel and to a liquid crystal display apparatus each having significantly improved color shift.

### BACKGROUND ART

In a liquid crystal display apparatus, an optical compensation film is conventionally used as a retardation film for compensating birefringence property of a liquid crystal cell. Such an optical compensation film is typically arranged between the liquid crystal cell and a polarizing plate (Patent Document 1, for example).

Meanwhile, with recent desire for a high definition and high performance liquid crystal display apparatus, further improvement in screen uniformity and display quality has been required. However, according to the conventional liquid crystal display apparatus of typical drive mode such as super twisted nematic (STN) mode, twisted nematic (TN) mode, in-plane switching (IPS) mode, vertical aligned (VA) mode, optically aligned birefringence (OCB) mode, hybrid aligned nematic (HAN) mode, or axially symmetric aligned microcell (ASM) mode, color shift is very large in a white display and a black display. Specific problems include a yellowish white display and a bluish black display.

### Patent Document 1: JP-A-2004-78203

### DISCLOSURE OF THE INVENTION

### Problems to be Solved by the Invention

The present invention has been made in view of solving the above-described conventional problems, and an object of the present invention is to provide a liquid crystal panel and a liquid crystal display apparatus each having significantly improved color shift.

### Means for Solving the Problems

According to one aspect of the invention, a liquid crystal panel is provided. The liquid crystal panel includes a backlight part emitting polarized light, an optical compensation layer, a first polarizer, a liquid crystal cell, and a second polarizer in the stated order from a backlight side.

In one embodiment of the invention, the optical compensation layer has an Nz coefficient within a range of 1<Nz<3.

In another embodiment of the invention, the optical compensation layer includes a stretched film of a polymer film containing as a main component cellulose ester or polycarbonate.

In still another embodiment of the invention, the backlight part emitting polarized light includes a light source part emitting natural light and a linearly polarized light separation film.

Instill another embodiment of the invention, the liquid crystal panel further includes a negative biaxial optical element between the first polarizer and the liquid crystal cell and/or between the second polarizer and the liquid crystal cell.

In still another embodiment of the invention, the negative biaxial optical element is formed of at least one non-liquid crystalline polymer material selected from polyamide, polyimide, polyester, polyether ketone, polyamideimide, and polyesterimide.

In still another embodiment of the invention, a slow axis of the optical compensation layer and an absorption axis of the first polarizer are perpendicular to each other.

In still another embodiment of the invention, the liquid crystal cell has drive mode selected from the group consisting of STN mode, TN mode, IPS mode, VA mode, OCB mode, HAN mode, and ASM mode.

According to another aspect of the invention, a liquid crystal display is provided. The liquid crystal display apparatus includes the liquid crystal panel.

### EFFECTS OF THE INVENTION

As described above, the optical compensation layer having specific optical properties is provided on an outer side of one polarizer (polarizer on a backlight side). The optical compensation layer provided on an outer side of the polarizer and having specific optical properties and the backlight part emitting polarized light are combined, to thereby significantly improve the color shift compared with that of the case employing backlight emitting natural light. That is, a phenomenon of changing color depending on an angle where the liquid crystal panel is seen from may be drastically suppressed. The reasons are not theoretically clarified. However, color compensation of backlight, which has been difficult with natural light, is presumably realized by converting light emitted from the backlight part to polarized light once and compensating the polarized light by the optical compensation layer. Such an effect is a finding obtained for the first time by producing a liquid crystal display apparatus employing a specific optical compensation layer and a backlight part emitting polarized light in combination, and is an unexpected excellent effect.

### BRIEF DESCRIPTION OF THE DRAWINGS

FIG. 1 A schematic sectional view of a liquid crystal panel according to a preferred embodiment of the present invention.

FIGS. 2A and 2B Schematic sectional views each illustrating an alignment state of liquid crystal molecules of a liquid crystal layer in the case where a liquid crystal display apparatus of the present invention employs a liquid crystal cell of VA mode.

FIGS. 3A to 3D Schematic sectional views each illustrating an alignment state of liquid crystal molecules of a liquid crystal layer in the case where a liquid crystal display apparatus of the present invention employs a liquid crystal cell of OCB mode.

FIG. 4 A schematic diagram illustrating an azimuth angle and a polar angle in measurement of hue and color shift.

FIGS. 5A and 5B XY chromaticity diagrams showing measurement results of color shift of a liquid crystal panel according to an example of the present invention.

FIGS. 6A and 6B XY chromaticity diagrams showing measurement results of color shift of a liquid crystal panel according to another example of the present invention.

FIGS. 7A and 7B XY chromaticity diagrams showing measurement results of color shift of a liquid crystal panel according to still another example of the present invention.

FIGS. 8A and 8B XY chromaticity diagrams showing measurement results of color shift of a liquid crystal panel according to a comparative example.

FIGS. 9A and 9B XY chromaticity diagrams showing measurement results of color shift of a liquid crystal panel according to another comparative example.

### DESCRIPTION OF SYMBOLS

10 backlight portion
11 light source
12 linearly polarized light separation film
20 optical compensation layer
30 first polarizer
40 liquid crystal cell
50 second polarizer
100 liquid crystal panel

### BEST MODE FOR CARRYING OUT THE INVENTION

A. Liquid Crystal Panel

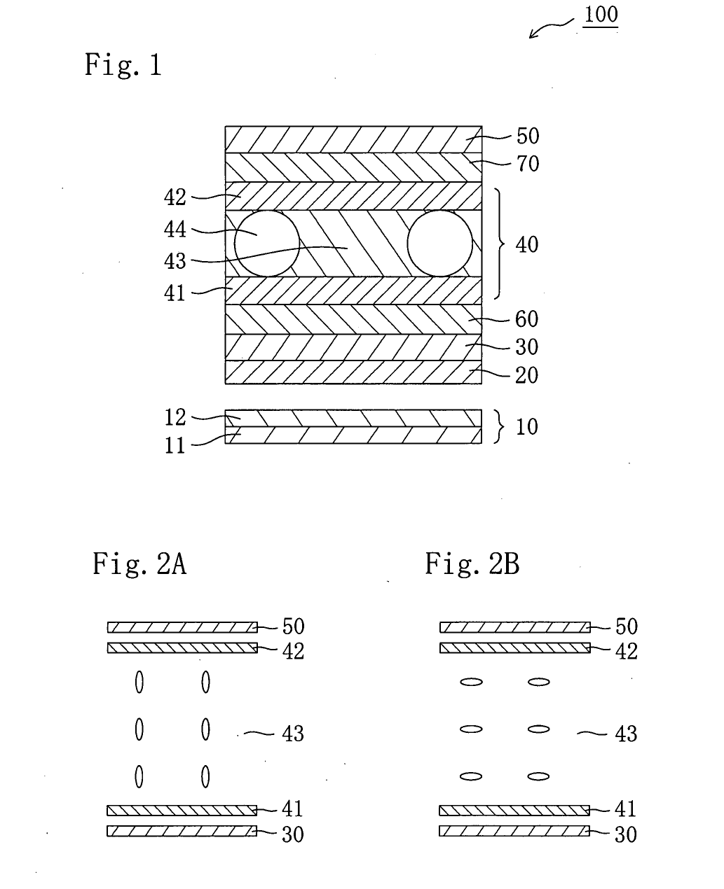

FIG. 1 is a schematic sectional view of a liquid crystal panel according to a preferred embodiment of the present invention. A liquid crystal panel 100 is provided with a backlight part 10 emitting polarized light, an optical compensation layer 20, a first polarizer 30, a liquid crystal cell 40, and a second polarizer 50 in the stated order from a backlight side. That is, in the present invention, the optical compensation layer 20 having specific optical properties is provided on an outer side of the polarizer 30 (details of the optical compensation layer 20 will be described in the section C below). The optical compensation layer provided on an outer side of the polarizer and having specific optical properties and the backlight part emitting polarized light are combined, to thereby significantly improve color shift compared with that of the case employing backlight emitting natural light. That is, a phenomenon of changing color depending on an angle where the liquid crystal panel is seen from may be drastically suppressed.

The first polarizer 30 and the second polarizer 50 are typically arranged such that respective absorption axes are perpendicular to each other. A slow axis of the optical compensation layer 20 and an absorption axis of the first polarizer 30 may be parallel to or perpendicular to each other. Preferably, the slow axis of the optical compensation layer 20 and the absorption axis of the first polarizer 30 are perpendicular to each other. The slow axis of the optical compensation layer 20 and the absorption axis of the first polarizer 30 are arranged to be perpendicular to each other, to thereby further improve the color shift. Note that in the specification of the present invention, the term “slow axis” refers to a direction providing a maximum in-plane refractive index.

The liquid crystal cell 40 is provided with: a pair of glass substrates 41 and 42; and a liquid crystal layer 43 as a display medium held between the glass substrates 41 and 42. The glass substrate (active matrix substrate) 41 is provided with: an active element (typically TFT) for controlling electrooptic properties of liquid crystals; a scanning line for providing a gate signal to the active element and a signal line for providing a source signal thereto (both not shown). The other glass substrate (color filter substrate) 42 is provided with color filters (not shown). The color filters may be provided in the active matrix substrate 41 as well. A distance (cell gap) between the glass substrates 41 and 42 is controlled by a spacer 44. An alignment film (not shown) formed of, for example, polyimide is provided on a side of each of the glass substrates 41 and 42 in contact with the liquid crystal layer 43.

Preferably, the liquid crystal panel 100 further includes a negative biaxial optical element 60 between the first polarizer 30 and the liquid crystal cell 40 and/or a negative biaxial optical element 70 between the second polarizer 50 and the liquid crystal cell 40. For practical use, any appropriate protective film (not shown) may be provided on at least one side of the first polarizer 30 and the second polarizer 50.

The liquid crystal cell 40 may employ any appropriate drive mode as long as effects of the present invention can be obtained. Specific examples of the drive mode include super twisted nematic (STN) mode, twisted nematic (TN) mode, in-plane switching (IPS) mode, vertical aligned (VA) mode, optically aligned birefringence (OCB) mode, hybrid aligned nematic (HAN) mode, and axially symmetric aligned microcell (ASM) mode. VA mode and OCB mode are preferred because the backlight part 10 and the optical compensation layer 20 to be used in the present invention are combined, to thereby significantly improve the color shift.

FIGS. 2A and 2B are each a schematic sectional view illustrating an alignment state of liquid crystal molecules in a VA mode. As shown in FIG. 2A, liquid crystal molecules are aligned vertically to the substrates 41 and 42 without application of a voltage. Such vertical alignment is realized by arranging nematic liquid crystal having negative dielectric anisotropy between the substrates each having a vertical alignment film formed thereon (not shown). When light (specifically, linear polarized light which passed through the first polarizer 30) enters the liquid crystal layer 43 in such a state from a surface of one substrate 41, the incident light advances along a longitudinal direction of the vertically aligned liquid crystal molecules. No birefringence occurs in the longitudinal direction of the liquid crystal molecules, and thus the incident light advances without changing a polarization direction and is absorbed by the second polarizer 50 having a polarizing axis perpendicular to the first polarizer 30. In this way, a dark state is displayed without application of a voltage (normally black mode). As shown in FIG. 2B, longitudinal axes of the liquid crystal molecules orientate parallel to the substrate surfaces when a voltage is applied between the electrodes. The liquid crystal molecules exhibit birefringence with linear polarized light entering the liquid crystal layer 43 in such a state, and a polarization state of the incident light changes in accordance with inclination of the liquid crystal molecules. Light passing through the liquid crystal layer during application of a predetermined maximum voltage is converted into linear polarized light having a polarization direction rotated by 90°, for example. Thus, the light passes through the second polarizer 50, and a bright state is displayed. Upon termination of voltage application, the display is returned to a dark state by an alignment restraining force. An applied voltage is changed to control inclination of the liquid crystal molecules, so as to change an intensity of light transmission from the second polarizer 50. As a result, display of gradation can be realized.

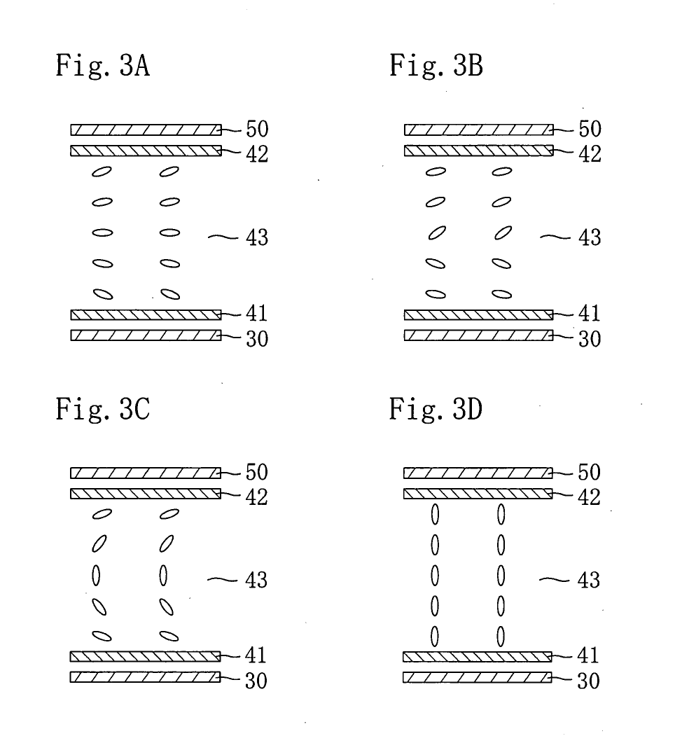

FIGS. 3A to 3D are each a schematic sectional view illustrating an alignment state of liquid crystal molecules in an OCB mode. The OCB mode is a display mode in which the liquid crystal layer 43 is constituted by so-called bend alignment. As shown in FIG. 3C, the bend alignment refers to an alignment state wherein: nematic liquid crystal molecules are aligned at a substantially parallel angle (alignment angle) in the vicinity of a substrate; the alignment angle of the liquid crystal molecules becomes vertical to a substrate plane toward the center of the liquid crystal layer; and the alignment angle changes successively and continuously to parallel with a facing substrate surface away from the center of the liquid crystal layer. Further, the bend alignment refers to an alignment state having no twist structure across the entire liquid crystal layer. Such bend alignment is formed as follows. As shown in FIG. 3A, the liquid crystal molecules have a substantially homogeneous alignment in a state without application of an electric field or the like (initial state). However, the liquid crystal molecules each have a pretilt angle, and a pretilt angle in the vicinity of the substrate is different from a pretilt angle in the vicinity of the opposite substrate. A predetermined bias voltage (generally 1.5 V to 1.9 V) is applied (low voltage application) to the liquid crystal molecules, to thereby realize spray alignment as shown in FIG. 3B and then into bend alignment as shown in FIG. 3C. Then, a display voltage (generally 5 V to 7 V) is applied (high voltage application) to the state of bend alignment, and thus the liquid crystal molecules align/stand substantially vertical to the substrate surface as shown in FIG. 3D. In a normally white display mode, light entering the liquid crystal layer in a state shown in FIG. 3D during high voltage application through the first polarizer 30 advances without changing a polarization direction and is absorbed by the second polarizer 50, to thereby display a dark state. Upon reduction of a display voltage, the alignment is returned to bend alignment to display a bright state by an alignment restraining force of rubbing treatment. A display voltage is changed to control inclination of the liquid crystal molecules, so as to change an intensity of light transmission from the polarizing plate. As a result, display of gradation can be realized. The liquid crystal display apparatus provided with an OCB mode liquid crystal cell allows switching of phase transition from a spray alignment state to a bend alignment state at a very high speed, and has excellent dynamic image display characteristics compared to those of a liquid crystal display apparatus provided with a liquid crystal cell of another drive mode such as a TN mode or an IPS mode.

The liquid crystal cell of OCB mode may employ one display mode of normally white mode providing a dark state (black display) during application of a high voltage, and a normally black mode providing a bright state (white display) during application of a high voltage.

A cell gap of the liquid crystal cell of OCB mode is preferably 2 μm to 10 μm, more preferably 3 μm to 9 μm, and particularly preferably 4 μm to 8 μm. A cell gap within the above ranges can reduce a response time and provide favorable display properties.

Nematic liquid crystals to be used in the liquid crystal cell of OCB mode preferably have positive dielectric anisotropy. Specific examples of the nematic liquid crystals having positive dielectric anisotropy include those described in JP-A-09-176645. Further, commercially available nematic liquid crystals may be used as they are. Examples of the commercially available nematic liquid crystals include “ZLI-4535” and “ZLI-1132” (trade names) available from Merck Ltd., Japan. A difference between an ordinary refractive index (no) and an extraordinary refractive index (ne) of the nematic liquid crystal, that is, a birefringence (Δn_{LC}) may appropriately be selected in accordance with the response speed, transmittance, and the like of the liquid crystals. The birefringence is preferably 0.05 to 0.30, more preferably 0.10 to 0.30, and furthermore preferably 0.12 to 0.30. Further, a pretilt angel of such nematic liquid crystals is preferably 1° to 10°, more preferably 2° to 8°, and particularly preferably 3° to 6°. A pretilt angle within the above ranges can reduce the response speed and provide favorable display properties.

The liquid crystal cell as described above may suitably be used for a liquid crystal display apparatus such as a personal computer, a liquid crystal television, a cellular phone, a personal digital assistant (PDA), or a projector.

B. Backlight Part

As described above, the backlight part 10 emits polarized light. Preferably, the backlight part 10 emits linearly polarized light. The polarized light (or linearly polarized light) is compensated by the optical compensation layer 20. Thus, compensation of a color of backlight itself, which has been difficult with backlight of natural light, is realized. As a result, the color shift of the liquid crystal panel can be improved significantly. In the present invention, the backlight part may be formed of a light source emitting polarized light alone, or formed of a light source emitting natural light and polarization means in combination. According to an embodiment as shown in FIG. 1, in one embodiment, the backlight part 10 includes a light source part 11 emitting natural light and a linearly polarized light separation film 12. In such a structure, the light source and the linearly polarized light separation film are both easily available, which is extremely preferred for practical use. In such a structure, a λ/4 plate can be omitted, and this structure may contribute to reduction in thickness of the liquid crystal panel.

The light source part 11 emitting natural light is generally produced by combining a point or linear light source and a light diffusion member. The light source part may have any appropriate structure. Typical examples of the light source part include a direct-type backlight and an edge-type backlight of a transmissive liquid crystal display apparatus. The direct-type backlight is formed of a linear light source (typically, a fluorescent lamp), a reflecting plate arranged in back of the linear light source, and a light scattering plate (such as an opaque plate) arranged in front of the linear light source. The edge-type backlight is known to be a surface light source having an easily reduced thickness than that of the direct-type backlight and having excellent brightness uniformity. In the edge-type backlight, a linear light source (typically, a fluorescent lamp) is arranged at an edge of a light guide body (such as a transparent acrylic plate). In the edge-type backlight, a diffusion layer is formed on a surface of the light guide body, for example, to allow light from the light source to exit from a desired surface of the light guide body. A surface excluding a front surface (light exiting surface) of the light guide body is covered with the reflecting plate. For uniform brightness, a diffusion effect by the diffusion layer is provided with a gradient, for example, in accordance with a distance from the light source (brightness distribution). For obtaining sufficient illumination surface brightness, exiting light is provided with directivity by a method involving stacking a diffusion plate on a light guide body subjected to Fresnel mirror working on a back surface, a method involving stacking the light guide body and a prism subjected to Fresnel working, or the like.

The linearly polarized light separation film 12 may employ any appropriate film capable of separating linearly polarized light from natural light or polarized light. Typical examples of such a linearly polarized light separation film include: a grid-type polarizer; a multilayer thin film laminate having a difference in refractive indices, formed of two or more kinds of materials, and including two or more layers; an evaporated multilayer thin film to be used in a beam splitter or the like and having different refractive indices; a multilayer thin film laminate, formed of two or more kinds of materials each having a refractive index, and including two or more birefringence layers; a stretched resin laminate having a refractive index, formed of two or more kinds of resins, and including two or more layers; and a film capable of separating linearly polarized light by allowing linearly polarized light to reflect/transmit in a perpendicular axial direction. For example, a multilayer laminate obtained by laminating alternately a material exhibiting retardation through stretching (such as polyethylene naphthalate, polyethylene terephthalate, or polycarbonate) or an acrylic resin (such as polymethyl methacrylate), and a resin having suppressed the exhibition level of retardation (such as a norbornene-based resin “Arton” available from JSR Corporation) may be uniaxially stretched and used. The linearly polarized light separation film is commercially available as DBEF, trade name, from Sumitomo 3M Ltd., for example. The thickness of the linearly polarized light separation film in the present invention is typically about 50 to 200 μm.

C. Optical Compensation Layer

An in-plane retardation (frontal retardation) Re of the optical compensation layer 20 may be optimized in accordance with the structure of the backlight part. For example, the in-plane retardation Re is preferably 50 to 400 nm, more preferably 100 to 350 nm, and most preferably 140 to 320 nm. Note that the in-plane retardation Re can be determined from an equation Re=(nx−ny)×d, where nx represents a refractive index of the optical compensation layer in a slow axis direction, ny represents a refractive index of the optical compensation layer in a fast axis direction, and d (nm) represents a thickness of the optical compensation layer. Re is typically measured by using light of wavelength of 590 nm. The slow axis refers to a direction providing a maximum in-plane refractive index, and the fast axis refers to a direction perpendicular to the slow axis in the same plane.

A thickness direction retardation Rth of the optical compensation layer 20 may be optimized in accordance with the structure of the backlight part. For example, the thickness direction retardation Rth is preferably 25 to 800 nm, more preferably 50 to 600 nm, and most preferably 180 to 480 nm. Note that the thickness direction retardation Rth is determined from an equation Rth=(nx−nz)×d, where nz represents a refractive index in a thickness direction of the film (optical compensation layer). Rth is also typically measured by using light of a wavelength of 590 nm.

An Nz coefficient (=Rth/Re) of the optical compensation layer 20 may be optimized in accordance with the backlight portion. In the present invention, the Nz coefficient is preferably in the range of 1<Nz<3, more preferably in the range of 1<Nz<2, furthermore preferably 1.1 to 1.7, and most preferably 1.4 to 1.7. The optical compensation layer 20 has a refractive index profile of nx>ny>nz. An optical compensation layer having such optical properties (that is, Re, Rth, a refractive index profile, and an Nz coefficient; in particular, an Nz coefficient) is used in combination with the backlight part, to thereby allow favorable compensation of a color of the backlight itself. Specifically, even in the case where the backlight itself is yellowish or bluish light, the optical compensation layer and the linearly polarized light separation film are used in combination, to thereby convert such light into white light. As a result, a liquid crystal panel (liquid crystal display apparatus) having very small color shift can be obtained.

The optical compensation layer 20 may be a monolayer or a laminate of two or more layers as long as the effects of the present invention can be provided. In the case of a laminate, a material constituting each layer of the laminate and a thickness of each layer thereof may be arbitrarily set as long as the entire laminate has the above optical characteristics.

The optical compensation layer may have any appropriate thickness as long as the effects of the present invention can be provided (for example, as long as the above optical characteristics are obtained). The optical compensation layer preferably has a thickness of 20 to 80 μm, more preferably 30 to 70 μm, further preferably 35 to 35 μm, and most preferably 38 to 60 μm.

The optical compensation layer may be formed by any appropriate method by using any appropriate material as long as the optical properties as described above can be obtained. Typically, the optical compensation layer is a stretched film of a polymer film containing as a main component a thermoplastic resin. The thermoplastic resin may employ any appropriate thermoplastic resin in accordance with the purpose. Specific examples of the thermoplastic resin include: general purpose plastics such as polyethylene, polypropylene, polynorbornene, polyvinyl chloride, a cellulose ester, polystyrene, an ABS resin, an AS resin, polymethylmethacrylate, polyvinyl acetate, and polyvinylidene chloride; general purpose engineering plastics such as polyamide, polyacetal, polycarbonate, modified polyphenylene ether, polybutylene terephthalate, and polyethylene terephthalate; and super engineering plastics such as polyphenylene sulfide, polysulfone, polyethersulfone, polyetheretherketone, polyarylate, a liquid crystal polymer, polyamideimide, polyimide, and polytetrafluoroethylene. Those thermoplastic resins may be used after appropriate polymer modification. Examples of the polymer modification include copolymerization, branching, crosslinking, and modifications in molecular terminals and stereoregularity. The thermoplastic resin may be alone, or two or more kinds thereof may be used in combination. Cellulose ester and polycarbonate are particularly preferred. Cellulose ester may be used, to thereby provide an optical compensation layer having excellent transparency, mechanical strength, heat stability, moisture barrier property, exhibition of retardation values, easy control of retardation values, adhesive property with a polarizer, and the like. Polycarbonate has excellent workability.

Any appropriate cellulose ester may be employed as the cellulose ester. Specific examples thereof include organic acid esters such as cellulose acetate, cellulose propionate, and cellulose butyrate. The cellulose ester may be a mixed organic acid ester in which a part of hydroxyl groups of cellulose are substituted by an acetyl group and another part of the hydroxyl groups of cellulose are substituted by a propionyl group, for example. The cellulose ester is produced, for example, through a method described in paragraphs [0040] and [0041] of JP 2001-188128 A.

Of cellulose esters, a cellulose ester having a repeating unit represented by the following general formula (A) is preferred because of excellent wavelength dispersion property of the retardation values and easily exhibited retardation values.

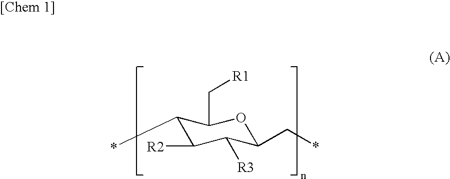

In the formula: R1 and R3 each independently represent an acetyl group or a propionyl group; and n represents an integer of 1 or more.

In a case where the cellulose ester contains an acetyl group, the degree of acetyl substitution is preferably 1.5 to 3.5, more preferably 2.0 to 3.0, and most preferably 2.4 to 2.9. In a case where the cellulose ester contains a propionyl group, the degree of propionyl substitution is preferably 0.5 to 3.0, more preferably 0.5 to 2.0, and most preferably 0.5 to 1.5. In a case where the cellulose ester is a mixed organic acid ester in which a part of hydroxyl groups of cellulose are substituted by an acetyl group and another part of the hydroxyl groups of cellulose are substituted by a propionyl group, a total of degree of acetyl substitution and degree of propionyl substitution is preferably 1.5 to 3.5, more preferably 2.0 to 3.0, and most preferably 2.4 to 2.9. In this case, the degree of acetyl substitution is preferably 1.0 to 2.8, and the degree of propionyl substitution is preferably 0.5 to 2.0.

In the specification of the present invention, a degree of acetyl substitution (or degree of propionyl substitution) refers to the number of hydroxyl groups, which are bonded to carbon atoms at 2, 3, and 6 positions in a cellulose backbone, substituted by acetyl groups (or propionyl groups). The acetyl groups (or propionyl groups) may unevenly substitute any carbon atoms at 2, 3, and 6 positions in a cellulose backbone, or may evenly substitute the carbon atoms at 2, 3, and 6 positions. The degree of acetyl substitution may be determined in accordance with ASTM-D817-91 (Test Method of Cellulose Acetate and the like). The degree of propionyl substitution may be determined in accordance with ASTM-D817-96 (Standard Test Methods of Testing Cellulose Acetate Propionate and Cellulose Acetate Butyrate).

The cellulose ester has a weight average molecular weight (Mw) of preferably 30,000 to 500,000, more preferably 50,000 to 400,000, and particularly preferably 80,000 to 300,000 determined through gel permeation chromatography (GPC) by using a tetrahydrofuran solvent. A weight average molecular weight of a cellulose ester within the above ranges can provide a polymer film with excellent mechanical strength, solubility, molding property, and casting workability.

Aromatic polycarbonate composed of an aromatic dihydric phenol component and a carbonate component is preferably used as polycarbonate. Aromatic polycarbonate can generally be obtained through a reaction between an aromatic dihydric phenol compound and a carbonate precursor. That is, aromatic polycarbonate can be obtained through: a phosgene method in which phosgene is blown into an aromatic dihydric phenol compound in the presence of caustic alkali and a solvent; or an ester exchange method in which an aromatic dihydric phenol compound and bisarylcabonate are subjected to ester exchange in the presence of a catalyst. Specific examples of the carbonate precursor include: phosgene; bischloroformates of dihydric phenols; diphenyl carbonate; di-p-tolyl carbonate; phenyl-p-tolyl carbonate; di-p-chlorophenyl carbonate; and dinaphthyl carbonate. Of those, phosgene and diphenyl carbonate are preferred.

Specific examples of the aromatic dihydric phenol compound to react with the carbonate precursor include: 2,2-bis(4-hydroxyphenyl)propane; 2,2-bis(4-hydroxy-3,5-dimethylphenyl)propane; bis(4-hydroxyphenyl)methane; 1,1-bis(4-hydroxyphenyl)ethane; 2,2-bis(4-hydroxyphenyl)butane; 2,2-bis(4-hydroxy-3,5-dimethylphenyl)butane; 2,2-bis(4-hydroxy-3,5-dipropylphenyl)propane; 1,1-bis(4-hydroxyphenyl)cyclohexane; and 1,1-bis(4-hydroxyphenyl)-3,3,5-trimethylcyclohexane. Aromatic dihydric phenol compound may be used alone or in combination.

Preferred examples thereof include: 2,2-bis(4-hydroxyphenyl)propane; 1,1-bis(4-hydroxyphenyl)cyclohexane; and 1,1-bis(4-hydroxyphenyl)-3,3,5-trimethylcyclohexane. Particularly preferably, 2,2-bis(4-hydroxyphenyl)propane and 1,1-bis(4-hydroxyphenyl)-3,3,5-trimethylcyclohexane are used in combination.

The polycarbonate using as an aromatic dihydric phenol compound 2,2-bis(4-hydroxyphenyl)propane and 1,1-bis(4-hydroxyphenyl)-3,3,5-trimethylcyclohexane in combination contains repeating units represented by the following formulae (B) and (C).

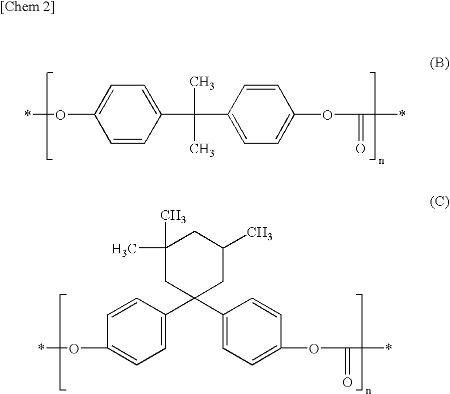

In a case where 2,2-bis(4-hydroxyphenyl)propane and 1,1-bis(4-hydroxyphenyl)-3,3,5-trimethylcyclohexane are used in combination as an aromatic dihydric phenol compound, the Tg or photoelastic coefficient of the optical compensation layer can be adjusted by varying a ratio of 2,2-bis(4-hydroxyphenyl)propane to 1,1-bis(4-hydroxyphenyl)-3,3,5-trimethylcyclohexane to be used. For example, a high content of 1,1-bis(4-hydroxyphenyl)-3,3,5-trimethylcyclohexane in the polycarbonate can increase Tg and decrease the photoelastic coefficient. A weight ratio of 2,2-bis(4-hydroxyphenyl)propane to 1,1-bis(4-hydroxyphenyl)-3,3,5-trimethylcyclohexane in the polycarbonate is preferably 2:8 to 8:2, more preferably 3:7 to 6:4, particularly preferably 3:7 to 5:5, and most preferably 4:6. The combined use of 2,2-bis(4-hydroxyphenyl)propane and 1,1-bis(4-hydroxyphenyl)-3,3,5-trimethylcyclohexane in the above weight ratios can provide a optical compensation layer having Tg and rigidity for excellent durability, self-bearing property, and stretch property.

In a case where two or more kinds of aromatic dihydric phenol compounds are used, a weight ratio of the aromatic dihydric phenol compound components can be determined by subjecting the polycarbonate-based resin to ¹H-NMR measurement.

The polycarbonate has a weight average molecular weight (Mw) of preferably 25,000 to 200,000, more preferably 30,000 to 150,000, particularly preferably 40,000 to 100,000, and most preferably 50,000 to 80,000 in polystyrene equivalents measured through a GPC method in which tetrahydrofuran is used as a developing solvent. The polycarbonate having a weight average molecular weight within the above ranges can provide a optical compensation layer having excellent mechanical strength.

The polymer film containing a thermoplastic resin as a main component may further contain any appropriate additive as required. Specific examples of the additive include a plasticizer, a thermal stabilizer, alight stabilizer, a lubricant, an antioxidant, a UV absorber, a flame retardant, a colorant, an antistatic agent, a compatibilizing agent, a crosslinking agent, and a thickener. The kind and amount of the additive to be used may be appropriately set depending on the purpose. A use amount of the additive is typically 0.1 to 10 or less (weight ratio) with respect to a total solid content in the polymer film as 100.

Any appropriate forming method may be employed as a method of obtaining the polymer film containing a thermoplastic resin as a main component. Specific examples of the forming method include compression molding, transfer molding, injection molding, extrusion molding, blow molding, powder molding, FRP molding, and solvent casting. Of those, extrusion molding and solvent casting are preferred because a highly smooth optical compensation layer with favorable optical uniformity can be obtained. Specifically, the extrusion molding involves: liquefying a resin composition containing a thermoplastic resin as a main component, a plasticizer, an additive, and the like under heating; extruding the melted resin composition into a thin film on a surface of a casting roller by using a T-die or the like; and cooling the whole to produce a film. Further, the solvent casting involves: defoaming a rich solution (dope) prepared by dissolving in a solvent a resin composition containing a thermoplastic resin as a main component, a plasticizer, an additive, and the like; uniformly casting the defoamed solution into a thin film on a surface of an endless stainless steel belt or rotating drum; and evaporating the solvent to produce a film. Forming conditions may be appropriately selected in accordance with the composition or kind of the resin to be used, the forming method, and the like.

Any appropriate stretching method may be employed as a method of forming a stretched film of a polymer film containing a thermoplastic resin as a main component. Specific examples of the stretching method include: a longitudinal uniaxial stretching method; a transverse uniaxial stretching method; a longitudinal and transverse simultaneous biaxial stretching method; and a longitudinal and transverse sequential biaxial stretching method. The stretching method may be a free end stretching method or a fixed end stretching method. Any appropriate stretching machine such as a roll stretching machine, a tenter stretching machine, or a biaxial stretching machine may be used as stretching means. In heat stretching, a stretching temperature may be continuously changed or may be changed in steps. The stretching may be performed in two or more steps. A longitudinal uniaxial stretching method or a transverse uniaxial stretching method is preferably used because a retardation film having small variation in slow axes in a film width direction may be obtained. The longitudinal uniaxial stretching method is appropriately used for enhancing uniaxial property of molecules (alignment direction of molecules is easily aligned in a specific direction) and has such a feature in that large retardation values can be obtained even with a material hardly causing retardation values. The transverse uniaxial stretching method allows roller production of a laminate having an optical compensation layer and a polarizer attached, in which a slow axis of the optical compensation layer and an absorption axis of the polarizer are perpendicular to each other, and has such a feature in that productivity may be significantly enhanced.

A temperature inside a stretching oven (also referred to as stretching temperature) during stretching of the polymer film is preferably equal to or higher than a glass transition temperature (Tg) of the polymer film because retardation values easily even out in a width direction and the film hardly crystallizes (becomes clouded). The stretching temperature is preferably Tg+1° C. to Tg+30° C. Specifically, the stretching temperature is preferably 110 to 200° C., and more preferably 120 to 170° C. The glass transition temperature can be determined through a method in accordance with JIS K7121-1987 by a DSC method.

A specific method of maintaining the temperature constant inside the stretching oven is not particularly limited, and may be appropriately selected from heating methods or temperature control methods using: an air-circulating thermostatic oven in which hot air or cool air circulates; a heater using microwaves, far infrared rays, or the like; a heated roller for temperature adjustment; a heat pipe roller; and a heated metal belt.

A stretch ratio during stretching of the polymer film may be appropriately determined in accordance with the composition of the polymer film, the kind of a volatile component or the like, the residual amount of the volatile component or the like, designed retardation values, and the like. For example, the stretch ratio is preferably 1.05 times to 2.00 times, and more preferably 1.10 to 1.80 times. A delivery speed during stretching is not particularly limited, but is preferably 0.5 to 20 m/min in consideration of the machine accuracy, stability, and the like of the stretching machine.

D. Polarizer

In the specification of the present invention, the term “polarizer” refers to a film which converts natural light or polarized light into any polarized light. Any appropriate polarizer may be employed as the first polarizer 30 or the second polarizer 50 used in the present invention depending on the purpose. Further, the first polarizer 30 and the second polarizer 50 may be identical to or different from each other. Specific examples of the polarizers include: a film prepared by adsorbing a dichromatic substance such as iodine or a dichromatic dye on a hydrophilic polymer film such as a polyvinyl alcohol-based film, a partially formalized polyvinyl alcohol-based film, or a partially saponified ethylene/vinyl acetate copolymer-based film and uniaxially stretching the film; and a polyene-based aligned film such as a dehydrated product of a polyvinyl alcohol-based film or a dechlorinated product of a polyvinyl chloride-based film. Of those, a polarizer prepared by adsorbing a dichromatic substance such as iodine on a polyvinyl alcohol-based film and uniaxially stretching the film is particularly preferred because of its high polarized dichromaticity.

The polarizer prepared by adsorbing iodine on a polyvinyl alcohol-based film and uniaxially stretching the film may be produced by, for example: immersing a polyvinyl alcohol-based film in an aqueous solution of iodine for coloring; and stretching the film to a 3 to 7 times length of the original length. The aqueous solution may contain boric acid, zinc sulfate, zinc chloride, or the like as required, or the polyvinyl alcohol-based film may be immersed in an aqueous solution of potassium iodide or the like. Further, the polyvinyl alcohol-based film may be immersed and washed in water before coloring as required. Washing the polyvinyl alcohol-based film with water not only allows removal of contamination on a film surface or washing away of an antiblocking agent, but also provides an effect of preventing unevenness such as uneven coloring by swelling of the polyvinyl alcohol-based film. The stretching of the film may be performed after coloring of the film with iodine, performed during coloring of the film, or performed followed by coloring of the film with iodine. The stretching may be performed in an aqueous solution of boric acid or potassium iodide, or in a water bath.

As a transmittance of the polarizer, a value measured by using light of a wavelength of 440 nm at 23° C. is preferably 41% to 45%, and more preferably 43% to 45%.

A degree of polarization of the polarizer is preferably 99.90% to 100%, and more preferably 99.95% to 100%. A degree of polarization within the above ranges can further increase a contrast ratio in a frontal direction in the case where the polarizer is used in a liquid crystal display apparatus. The degree of polarization may be measured by using a spectrophotometer “DOT-3”, trade name, manufactured by Murakami Color Research Laboratory.

The thickness of the polarizer may appropriately be selected in consideration of optical properties such as degree of polarization, convenience in production such as mechanical strength, and the like. The thickness is preferably 1 μm to 80 μm, more preferably 10 μm to 50 μm, and particularly preferably 20 μm to 40 μm. A thickness within the above ranges can contribute to reduction in thickness of a liquid crystal display apparatus.

E. Protective Film of Polarizer

As described above, a protective film may be provided on at least one side of the first polarizer 30 and the second polarizer 50 for practical use. The protective film is provided, to thereby prevent degradation of the polarizer. Any appropriate protective film may be employed as the protective film. The protective film consists of a material such as a thermoplastic resin having excellent transparency, mechanical strength, thermal stability, water shielding property, anisotropy, and the like, for example. Specific examples of the thermoplastic resin include an acetate resin such as triacetylcellulose (TAC), a polyester resin, a polyether sulfone resin, a polysulfone resin, a polycarbonate resin, a polyamide resin, a polyimide resin, a polyolefin resin, an acrylic resin, a polynorbornene resin, a cellulose resin, a polyallylate resin, a polystyrene resin, a polyvinyl alcohol resin, a polyacrylic resin, and a mixture thereof. A further example thereof includes an acrylic-based, urethane-based, acrylic urethane-based, epoxy-based, or silicone-based thermosetting resin or UV-curing resin. Of those, a TAC film subjected to surface saponization treatment with alkali or the like is preferable from the viewpoints of polarization characteristics and durability.

Further, a polymer film formed of a resin composition described in JP 2001-343529A (WO 01/37007) may be used as a protective film, for example. Specifically, the film is formed of a mixture of a thermoplastic resin having a substituted imide group or unsubstituted imide group on a side chain, and a thermoplastic resin having a substituted phenyl group or unsubstituted phenyl group and a cyano group on a side chain. A specific example thereof includes a resin composition containing an alternate copolymer of isobutene and N-methylene maleimide, and an acrylonitrile/styrene copolymer. An extruded product of such a resin composition may be used, for example.

It is preferable that the protective film be transparent and have no color. Specifically, the protective film has a thickness retardation Rth of preferably −90 nm to +75 nm, more preferably −80 nm to +60 nm, and most preferably −70 nm to +45 nm. A thickness retardation Rth of the protective film falling within the above range may eliminate optical coloring of the polarizer attributed to the protective film.

A thickness of the protective film may be arbitrarily set depending on the purpose. A thickness of the protective film is generally 500 μm or less, preferably 5 to 300 μm, and more preferably 5 to 150 μm.

F. Negative Biaxial Optical Element

As described above, the negative biaxial optical element 60 is provided between the liquid crystal cell 40 and the first polarizer 30, and the negative biaxial optical element 70 is provided between the liquid crystal cell 40 and the second polarizer 50 as required. The negative biaxial optical elements 60 and 70 may be identical to or different from each other. Note that in the specification of the present invention, the term “negative biaxial optical element” refers to an optical element having a refractive index profile of nx>ny>nz. Optical properties of the negative biaxial optical elements 60 and 70 may appropriately be set in accordance with the drive mode of the liquid crystal cell. For example, in the case where the liquid crystal display apparatus (liquid crystal cell) employs VA mode, the in-plane retardation of the negative biaxial optical element is preferably 5 to 150 nm, more preferably 10 to 100 nm, and most preferably 15 to 80 nm. For example, in the case where the liquid crystal display apparatus employs OCB mode, the in-plane retardation of the negative biaxial optical element is preferably 5 to 400 nm, more preferably 10 to 300 nm, and most preferably 15 to 200 nm.

The thickness direction retardation of the negative biaxial optical element may appropriately be set in accordance with the drive mode of the liquid crystal cell. For example, in the case where the liquid crystal display apparatus (liquid crystal cell) employs VA mode, the thickness direction retardation of the negative biaxial optical element is preferably 100 to 300 nm, more preferably 120 to 280 nm, and most preferably 150 to 260 nm. For example, in the case where the liquid crystal display apparatus employs OCB mode, the thickness direction retardation of the negative biaxial optical element is preferably 100 to 1,000 nm, more preferably 120 to 500 nm, and most preferably 150 to 400 nm.

The Nz coefficient of the negative biaxial optical element may appropriately be set in accordance with the drive mode of the liquid crystal cell. For example, in the case where the liquid crystal display apparatus employs VA mode, the Nz coefficient is preferably 2 to 10, more preferably 2 to 8, and most preferably 2 to 6. For example, in the case where the liquid crystal display apparatus employs OCB mode, the Nz coefficient is preferably 2 to 20, more preferably 2 to 10, and most preferably 2 to 8.

The thickness of each of the negative biaxial optical elements 60 and 70 may employ any appropriate thickness as long as the optical properties as described above can be satisfied. Typically, the thickness of each of the negative biaxial optical elements 60 and 70 is 0.1 to 50 μm, preferably 0.5 to 30 μm, and more preferably 1 to 20 μm. Such a thickness can contribute to reduction in thickness of the liquid crystal display apparatus, and an optical element having excellent viewing angle compensation performance and uniform retardations can be obtained. The thicknesses of the negative biaxial optical elements 60 and 70 may be identical to or different from each other.

Any suitable materials may be employed as a material constituting the negative biaxial optical element as long as the negative biaxial optical element has the above optical characteristics. An example of such a material includes a non-liquid crystalline material. The material is particularly preferably a non-liquid crystalline polymer. The non-liquid crystalline material differs from a liquid crystalline material and may form an optically uniaxial film with nx>nz or ny>nz as property of the non-liquid crystalline material, regardless of orientation of the substrate. As a result, the non-liquid crystalline material may employ not only an orientated substrate, but also an unorientated substrate in a step of forming the negative biaxial optical element. Further, a step of applying an orientation film on a substrate surface, a step of laminating an orientation film, or the like may be omitted even when an unorientated substrate is employed.

A preferred example of the non-liquid crystalline material includes a polymer such as polyamide, polyimide, polyester, polyetherketone, polyamideimide, or polyesterimide since such a material has excellent thermal resistance, excellent chemical resistance, excellent transparency, and sufficient rigidity. One type of polymer may be used, or a mixture of two or more types thereof having different functional groups such as a mixture of polyaryletherketone and polyamide may be used. Of those, polyimide is particularly preferred in view of high transparency, high orientation, and high extension.

A molecular weight of the polymer is not particularly limited. However, the polymer has a weight average molecular weight (Mw) of preferably within a range of 1,000 to 1,000,000, more preferably within a range of 2,000 to 500,000, for example.

Polyimide which has high in-plane orientation and which is soluble in an organic solvent is preferred as polyimide used in the present invention, for example. More specifically, a polymer disclosed in JP 2000-511296 A, containing a condensation polymerization product of 9,9-bis(aminoaryl)fluorene and aromatic tetracarboxylic dianhydride, and containing at least one repeating unit represented by the following formula (1) can be used.

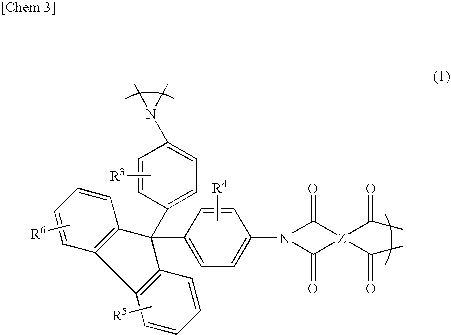

In the above formula (1), R³ to R⁶ independently represent at least one type of substituent selected from hydrogen, a halogen, a phenyl group, a phenyl group substituted with 1 to 4 halogen atoms or 1 to 4 alkyl groups each having 1 to 10 carbon atoms, and an alkyl group having 1 to 10 carbon atoms. Preferably, R³ to R⁶ independently represent at least one type of substituent selected from a halogen, a phenyl group, a phenyl group substituted with 1 to 4 halogen atoms or 1 to 4 alkyl groups each having 1 to 10 carbon atoms, and an alkyl group having 1 to 10 carbon atoms.

In the above formula (1), Z represents a tetravalent aromatic group having 6 to 20 carbon atoms, and preferably represents a pyromellitic group, a polycyclic aromatic group, a derivative of the polycyclic aromatic group, or a group represented by the following formula (2), for example.

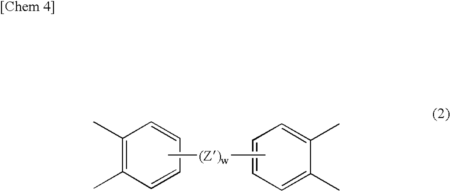

In the above formula (2), Z′ represents a covalent bond, a C(R⁷) 2 group, a CO group, an O atom, an S atom, an SO₂ group, an Si (C₂H₅)₂ group, or an NR⁸ group. A plurality of Z's may be the same or different from each other. w represents an integer of 1 to 10. R⁷s independently represent hydrogen or a C(R⁹)₃ group. R⁸ represents hydrogen, an alkyl group having 1 to about 20 carbon atoms, or an aryl group having 6 to 20 carbon atoms. A plurality of R⁸s may be the same or different from each other. R⁹s independently represent hydrogen, fluorine, or chlorine.

An example of the polycyclic aromatic group includes a tetravalent group derived from naphthalene, fluorene, benzofluorene, or anthracene. An example of the substituted derivative of the polycyclic aromatic group includes the above polycyclic aromatic group substituted with at least a group selected from an alkyl group having 1 to 10 carbon atoms, a fluorinated derivative thereof, and a halogen such as F or Cl.

Other examples of the polyimide include: a homopolymer disclosed in JP 08-511812 A and containing a repeating unit represented by the following general formula (3) or (4); and polyimide disclosed therein and containing a repeating unit represented by the following general formula (5). Note that, polyimide represented by the following formula (5) is a preferred form of the homopolymer represented by the following formula (3).

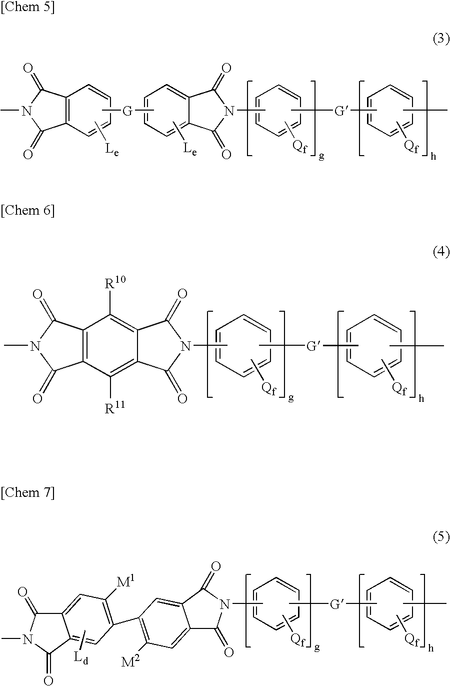

In the above general formulae (3) to (5), G and G′ independently represent a covalent bond, a CH₂ group, a C(CH₃)₂ group, a C(CF₃)₂ group, a C(CX₃)₂ group (wherein, X represents a halogen), a CO group, an O atom, an S atom, an SO₂ group, an Si(CH₂CH₃)₂ group, or an N(CH₃) group, for example. G and G′ may be the same or different from each other.

In the above formulae (3) and (5), L is a substituent, and d and e each represent the number of the substituents. L represents a halogen, an alkyl group having 1 to 3 carbon atoms, a halogenated alkyl group having 1 to 3 carbon atoms, a phenyl group, or a substituted phenyl group, for example. A plurality of Ls may be the same or different from each other. An example of the substituted phenyl group includes a substituted phenyl group having at least one type of substituent selected from a halogen, an alkyl group having 1 to 3 carbon atoms, and a halogenated alkyl group having 1 to 3 carbon atoms, for example. Examples of the halogen include fluorine, chlorine, bromine, and iodine. d represents an integer of 0 to 2, and e represents an integer of 0 to 3.

In the above formulae (3) to (5), Q is a substituent, and f represents the number of the substituents. Q represents an atom or a group selected from hydrogen, a halogen, an alkyl group, a substituted alkyl group, a nitro group, a cyano group, a thioalkyl group, an alkoxy group, an aryl group, a substituted aryl group, an alkyl ester group, and a substituted alkyl ester group, for example. A plurality of Qs may be the same or different from each other. Examples of the halogen include fluorine, chlorine, bromine, and iodine. An example of the substituted alkyl group includes a halogenated alkyl group. An example of the substituted aryl group includes a halogenated aryl group. f represents an integer of 0 to 4, and g represents an integer of 0 to 3. h represents an integer of 1 to 3. g and h are each preferably larger than 1.

In the above formula (4), R¹⁰ and R¹¹ independently represent an atom or a group selected from hydrogen, a halogen, a phenyl group, a substituted phenyl group, an alkyl group, and a substituted alkyl group. Preferably, R¹⁰ and R¹¹ independently represent a halogenated alkyl group.

In the above formula (5), M¹ and M² independently represent a halogen, an alkyl group having 1 to 3 carbon atoms, a halogenated alkyl group having 1 to 3 carbon atoms, a phenyl group, or a substituted phenyl group, for example. Examples of the halogen include fluorine, chlorine, bromine, and iodine. An example of the substituted phenyl group includes a substituted phenyl group having at least one type of substituent selected from the group consisting of a halogen, an alkyl group having 1 to 3 carbon atoms, and a halogenated alkyl group having 1 to 3 carbon atoms.

A specific example of the polyimide represented by the above formula (3) includes a compound represented by the following formula (6).

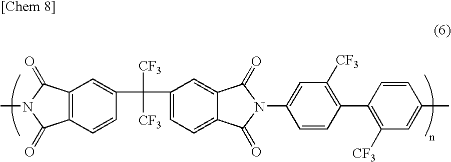

Another example of the polyimide includes a copolymer prepared through arbitrary copolymerization of acid dianhydride having a skeleton (repeating unit) other than that as described above and diamine.

An example of the acid dianhydride includes an aromatic tetracarboxylic dianhydride. Examples of the aromatic tetracarboxylic dianhydride include pyromellitic dianhydride, benzophenone tetracarboxylic dianhydride, naphthalene tetracarboxylic dianhydride, heterocyclic aromatic tetracarboxylic dianhydride, and 2,2′-substituted biphenyltetracarboxylic dianhydride.

Examples of the pyromellitic dianhydride include: pyromellitic dianhydride; 3,6-diphenyl pyromellitic dianhydride; 3,6-bis(trifluoromethyl)pyromellitic dianhydride; 3,6-dibromopyromellitic dianhydride; and 3,6-dichloropyromellitic dianhydride. Examples of the benzophenone tetracarboxylic dianhydride include: 3,3′,4,4′-benzophenone tetracarboxylic dianhydride; 2,3,3′,4′-benzophenone tetracarboxylic dianhydride; and 2,2′,3,3′-benzophenonetetracarboxylic dianhydride. Examples of the naphthalene tetracarboxylic dianhydride include: 2,3,6,7-naphthalene tetracarboxylic dianhydride; 1,2,5,6-naphthalene tetracarboxylic dianhydride; and 2,6-dichloronaphthalene-1,4,5,8-tetracarboxylic dianhydride. Examples of the heterocyclic aromatic tetracarboxylic dianhydride include: thiophene-2,3,4,5-tetracarboxylic dianhydride; pyrazine-2,3,5,6-tetracarboxylic dianhydride; and pyridine-2,3,5,6-tetracarboxylic dianhydride. Examples of the 2,2′-substituted biphenyltetracarboxylic dianhydride include: 2,2′-dibromo-4,4′,5,5′-biphenyltetracarboxylic dianhydride; 2,2′-dichloro-4,4′,5,5′-biphenyltetracarboxylic dianhydride; and 2,2′-bis(trifluoromethyl)-4,4′,5,5′-biphenyltetracarboxylic dianhydride.

Further examples of the aromatic tetracarboxylic dianhydride include: 3,3′,4,4′-biphenyltetracarboxylic dianhydride; bis(2,3-dicarboxyphenyl)methane dianhydride; bis(2,5,6-trifluoro-3,4-dicarboxyphenyl)methane dianhydride; 2,2-bis(3,4-dicarboxyphenyl)-1,1,1,3,3,3-hexafluoropropane dianhydride; 4,4′-bis(3,4-dicarboxyphenyl)-2,2-diphenylpropane dianhydride; bis(3,4-dicarboxyphenyl)ether dianhydride; 4,4′-oxydiphthalic dianhydride; bis(3,4-dicarboxyphenyl)sulfonic dianhydride; 3,3′,4,4′-diphenylsulfone tetracarboxylic dianhydride; 4,4′-[4,4′-isopropylidene-di(p-phenyleneoxy)]bis(phthalic anhydride); N,N-(3,4-dicarboxyphenyl)-N-methylamine dianhydride; and bis(3,4-dicarboxyphenyl)diethylsilane dianhydride.

Of those, the aromatic tetracarboxylic dianhydride is preferably 2,2′-substituted biphenyltetracarboxylic dianhydride, more preferably 2,2′-bis(trihalomethyl)-4,4′,5,5′-biphenyltetracarboxylic dianhydride, and furthermore preferably 2,2′-bis(trifluoromethyl)-4,4′,5,5′-biphenyltetracarboxylic dianhydride.

An example of the diamine includes aromatic diamine. Specific examples of the aromatic diamine include benzenediamine, diaminobenzophenone, naphthalenediamine, heterocyclic aromatic diamine, and other aromatic diamines.

Examples of the benzenediamine include benzenediamines such as o-, m-, or p-phenylenediamine, 2,4-diaminotoluene, 1,4-diamino-2-methoxybenzene, 1,4-diamino-2-phenylbenzene, and 1,3-diamino-4-chlorobenzene. Examples of the diaminobenzophenone include 2,2′-diaminobenzophenone and 3,3′-diaminobenzophenone. Examples of the naphthalenediamine include 1,8-diaminonaphthalene and 1,5-diaminonaphthalene. Examples of the heterocyclic aromatic diamine include 2,6-diaminopyridine, 2,4-diaminopyridine, and 2,4-diamino-S-triazine.

Further examples of the aromatic diamine include: 4,4′-diaminobiphenyl; 4,4′-diaminodiphenylmethane; 4,4′-(9-fluorenylidene)-dianiline; 2,2′-bis(trifluoromethyl)-4,4′-diaminobiphenyl; 3,3′-dichloro-4,4′-diaminodiphenylmethane; 2,2′-dichloro-4,4′-diaminobiphenyl; 2,2′,5,5′-tetrachlorobenzidine; 2,2-bis(4-aminophenoxyphenyl)propane; 2,2-bis(4-aminophenyl)propane; 2,2-bis(4-aminophenyl)-1,1,1,3,3,3-hexafluoropropane; 4,4′-diaminodiphenyl ether; 3,4′-diaminodiphenyl ether; 1,3-bis(3-aminophenoxy)benzene; 1,3-bis(4-aminophenoxy)benzene; 1,4-bis(4-aminophenoxy)benzene; 4,4′-bis(4-aminophenoxy)biphenyl; 4,4′-bis(3-aminophenoxy)biphenyl; 2,2-bis[4-(4-aminophenoxy)phenyl]propane; 2,2-bis[4-(4-aminophenoxy)phenyl]-1,1,1,3,3,3-hexafluoropropane; 4,4′-diaminodiphenyl thioether; and 4,4′-diaminodiphenylsulfone.

An example of the polyetherketone includes polyaryletherketone disclosed in JP 2001-049110 A and represented by the following general formula (7).

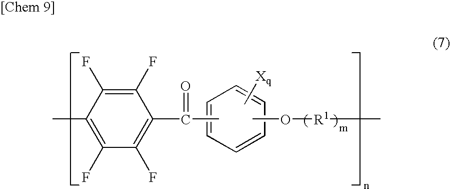

In the above formula (7), X represents a substituent, and q represents the number of the substituents. X represents a halogen atom, a lower alkyl group, a halogenated alkyl group, a lower alkoxy group, or a halogenated alkoxy group, for example. A plurality of Xs may be the same or different from each other.

Examples of the halogen atom include a fluorine atom, a bromine atom, a chlorine atom, and an iodine atom. Of those, a fluorine atom is preferred. The lower alkyl group is preferably an alkyl group having a straight chain or branched chain of 1 to 6 carbon atoms, more preferably an alkyl group having a straight chain or branched chain of 1 to 4 carbon atoms. More specifically, the lower alkyl group is preferably a methyl group, an ethyl group, a propyl group, an isopropyl group, a butyl group, an isobutyl group, a sec-butyl group, or a tert-butyl group, and particularly preferably a methyl group or an ethyl group. An example of the halogenated alkyl group includes a halide of the above lower alkyl group such as a trifluoromethyl group. The lower alkoxy group is preferably an alkoxy group having a straight chain or branched chain of 1 to 6 carbon atoms, more preferably an alkoxy group having a straight chain or branched chain of 1 to 4 carbon atoms. More specifically, the lower alkoxy group is preferably a methoxy group, an ethoxy group, a propoxy group, an isopropoxy group, a butoxy group, an isobutoxy group, a sec-butoxy group, or a tert-butoxy group, and particularly preferably a methoxy group or an ethoxy group. An example of the halogenated alkoxy group includes a halide of the above lower alkoxy group such as a trifluoromethoxy group.

In the above formula (7), q is an integer of 0 to 4. In the above formula (7), preferably, q=0, and a carbonyl group and an oxygen atom of ether bonded to both ends of a benzene ring are located in para positions.

In the above formula (7), R¹ is a group represented by the following formula (8), and m is an integer of 0 or 1.

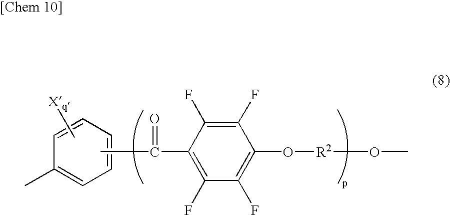

In the above formula (8), X′ represents a substituent which is the same as X in the above formula (7), for example. In the above formula (8), a plurality of X's may be the same or different from each other. q′ represents the number of the substituents X′. q, is an integer of 0 to 4, and q′ is preferably 0. p is an integer of 0 or 1.

In the above formula (8), R² represents a divalent aromatic group. Examples of the divalent aromatic group include: an o-, m-, or p-phenylene group; and a divalent group derived from naphthalene, biphenyl, anthracene, o-, m-, or p-terphenyl, phenanthrene, dibenzofuran, biphenyl ether, or biphenyl sulfone. In the divalent aromatic group, hydrogen directly bonded to an aromatic group may be substituted with a halogen atom, a lower alkyl group, or a lower alkoxy group. Of those, R² is preferably an aromatic group selected from groups represented by the following formulae (9) to (15).

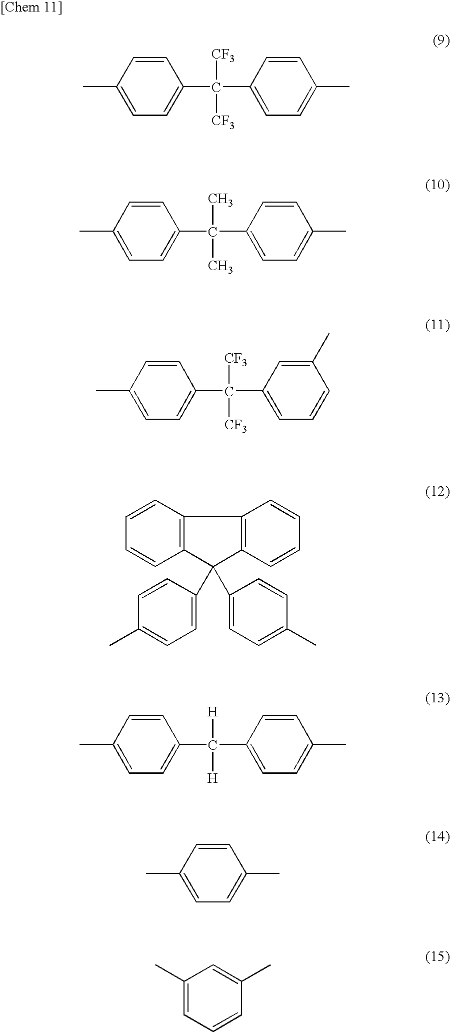

In the above formula (7), R¹ is preferably a group represented by the following formula (16). In the following formula (16), R² and p are defined as those in the above formula (8).

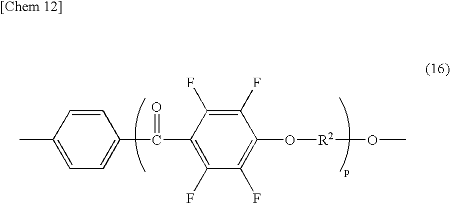

In the above formula (7), n represents a degree of polymerization. n falls within a range of 2 to 5,000, preferably within a range of 5 to 500, for example. Polymerization may involve polymerization of repeating units of the same structure or polymerization of repeating units of different structures. In the latter case, a polymerization form of the repeating units may be block polymerization or random polymerization.

Terminals of the polyaryletherketone represented by the above formula (7) are preferably a fluorine atom on a p-tetrafluorobenzoylene group side and a hydrogen atom on an oxyalkylene group side. Such polyaryletherketone can be represented by the following general formula (17), for example. In the following formula (17), n represents the same degree of polymerization as that in the above formula (7).

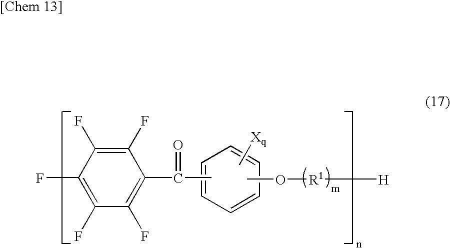

Specific examples of the polyaryletherketone represented by the above formula (7) include compounds represented by the following formulae (18) to (21). In each of the following formulae, n represents the same degree of polymerization as that in the above formula (7).

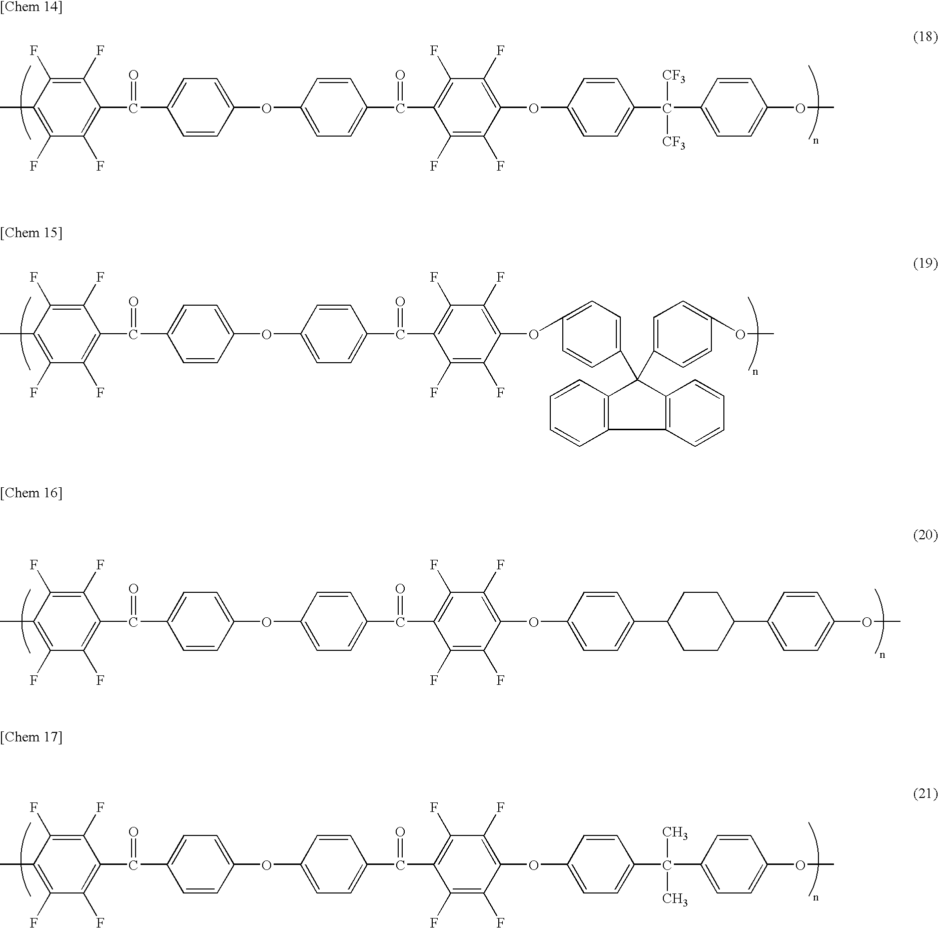

In addition, an example of polyamide or polyester includes polyamide or polyester disclosed in JP 10-508048 A. A repeating unit thereof can be represented by the following general formula (22), for example.

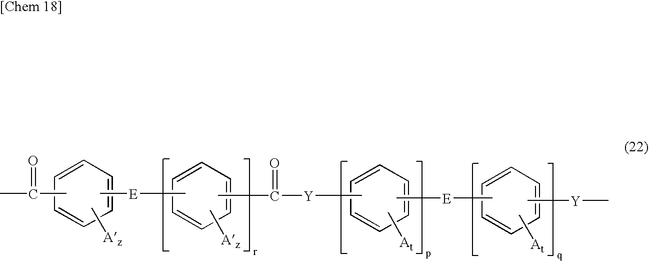

In the above formula (22), Y represents O or NH. E represents at least one selected from a covalent bond, an alkylene group having 2 carbon atoms, a halogenated alkylene group having 2 carbon atoms, a CH₂ group, a C(CX₃)₂ group (wherein, X is a halogen or hydrogen), a CO group, an O atom, an S atom, an SO₂ group, an Si(R)₂ group, and an N(R) group, for example. A plurality of Es may be the same or different from each other. In E, R is at least one of an alkyl group having 1 to 3 carbon atoms and a halogenated alkyl group having 1 to 3 carbon atoms, and is located in a meta or para position with respect to a carbonyl functional group or a Y group.

In the above formula (22), A and A′ each represent a substituent, and t and z represent the numbers of the respective substituents. p represents an integer of 0 to 3, and q represents an integer of 1 to 3. r represents an integer of 0 to 3.

A is selected from hydrogen, a halogen, an alkyl group having 1 to 3 carbon atoms, a halogenated alkyl group having 1 to 3 carbon atoms, an alkoxy group represented by OR (wherein, R is defined as above), an aryl group, a substituted aryl group prepared through halogenation or the like, an alkoxycarbonyl group having 1 to 9 carbon atoms, an alkylcarbonyloxy group having 1 to 9 carbon atoms, an aryloxycarbonyl group having 1 to 12 carbon atoms, an arylcarbonyloxy group having 1 to 12 carbon atoms and its substituted derivatives, an arylcarbamoyl group having 1 to 12 carbon atoms, and arylcarbonylamino group having 1 to 12 carbon atoms and its substituted derivatives, for example. A plurality of As may be the same or different from each other. A′ is selected from a halogen, an alkyl group having 1 to 3 carbon atoms, a halogenated alkyl group having 1 to 3 carbon atoms, a phenyl group, and a substituted phenyl group, for example. A plurality of A's may be the same or different from each other. Examples of the substituent on a phenyl ring of the substituted phenyl group include a halogen, an alkyl group having 1 to 3 carbon atoms, a halogenated alkyl group having 1 to 3 carbon atoms, and the combination thereof. t represents an integer of 0 to 4, and z represents an integer of 0 to 3.

The repeating unit of the polyamide or polyester represented by the above formula (22) is preferably a repeating unit represented by the following general formula (23).

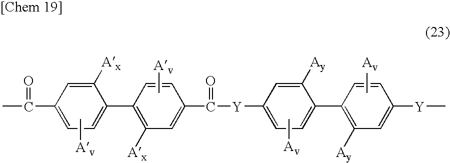

In the above formula (23), A, A′, and Y are defined as those in the above formula (22). v represents an integer of 0 to 3, preferably an integer of 0 to 2. x and y are each 0 or 1, but are not both 0.

The negative biaxial optical element is typically obtained by: applying the solution of a non-liquid crystalline polymer to a substrate film; removing a solvent in the solution to form a layer of a non-liquid crystalline polymer; and peeling off the formed layer of a non-liquid crystalline polymer from the substrate film as required.

Preferably, the production method as described above involves treatment for providing optical biaxial property (nx>ny>nz). Such treatment is conducted, to thereby assuredly provide a difference in refractive index (nx>ny) in the same plane and provide an optical element (that is, the negative biaxial optical element) having optical biaxial property (nx>ny>nz). That is, without such treatment, an optical element having optical uniaxial property (nx=ny>nz) may be obtained. Examples of a method of providing a difference in refractive index in the same plane include the following methods. The first method involves: applying the solution to a transparent polymer film subjected to stretching treatment; and drying the whole. According to the first method, optical biaxial property can be attained through shrinkage of the transparent polymer film. The second method involves: applying the solution to an unstretched transparent polymer film; drying the whole; and stretching the resultant under heating. According to the second method, optical biaxial property can be attained through stretching of the transparent polymer film. An example of the polymer film to be used in those methods is a plastic film to be used for a protective film of the polarizer (section E).

Hereinafter, the present invention will be described in more detail by way of examples, but the present invention is not limited to the examples. Methods of measuring characteristics in the examples are as described below.

(1) Measurement of Retardation

Refractive indices nx, ny, and nz of a sample film were measured using an automatic birefringence analyzer (Automatic birefringence analyzer KOBRA-21ADH, manufactured by Oji Scientific Instruments), and an in-plane retardation Re, and a thickness retardation Rth were calculated. Further, the Nz coefficient was measured by Rth/Re. A measurement temperature was 23° C. and a measurement wavelength was 590 nm.

(2) Measurement of Hue

A white image and a black image were displayed on the liquid crystal display apparatus produced, and a perpendicular hue was measured using “EZ Contrast 160D” (trade name, manufactured by ELDIM SA) with respect to the display apparatus.

(3) Color Shift

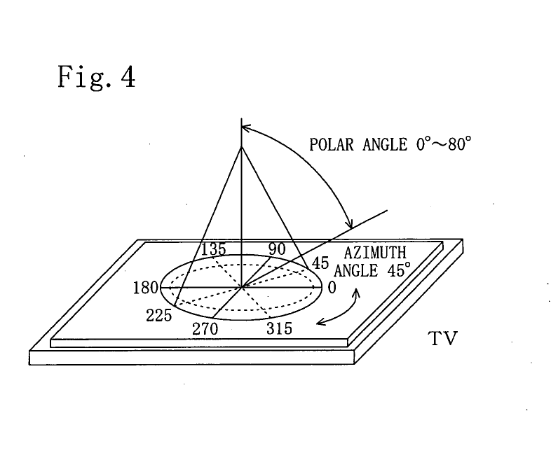

A color tone of the liquid crystal display apparatus was measured while a polar angle was changed from 0° to 80° in a direction of an azimuth angle of 45° using “EZ Contrast 160D” (trade name, manufactured by ELDIM SA). The results were plotted on an XY chromaticity diagram. Note that FIG. 4 shows the azimuth angle and the polar angle. In FIG. 4, a 0° to −180° direction refers to a direction of an absorption axis of a polarizer on a viewer side.

### REFERENCE EXAMPLE 1

### Formation of Negative Biaxial Optical Element

Polyimide represented by the following formula (6), synthesized from 2,2-bis(3,4-dicarboxyphenyl)hexafluoropropane dianhydride (6FDA) and 2,2′-bis(trifluoromethyl)-4,4′-diaminobiphenyl (TFMB), and having a weight average molecular weight (Mw) of 70,000 was dissolved in cyclohexanone, to thereby prepare a 15 wt % polyimide solution. Note that preparation of polyimide or the like was carried out by referring to a method described in a document (F. Li et al., Polymer 40 (1999) 4571-4583). Meanwhile, a triacetylcellulose (TAC) film having a thickness of 80 μm was horizontally stretched 1.3 times at 175° C. through fixed end transverse stretching, to thereby produce a stretched TAC film having a thickness of 75 μm as a substrate film. The polyimide solution was applied onto the substrate film to be dried at 100° C. for 10 minutes. As a result, an optical film A having a negative biaxial optical element on the substrate film was obtained. The negative biaxial optical element had an in-plane retardation of 60 nm and thickness retardation of 240 nm. Note that the negative biaxial optical element had optical characteristics of nx>ny>nz. The substrate film (stretched TAC film) had a Δn of about 0.0006.

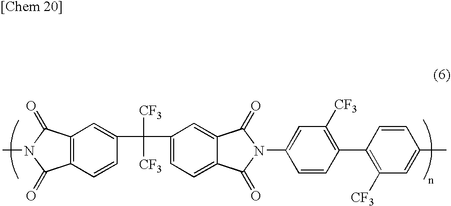

### REFERENCE EXAMPLE 2

### Production of Laminate with First Polarizer and Negative Biaxial Optical Element

A polyvinyl alcohol film was colored in an aqueous solution containing iodine and then uniaxially stretched 6 times between rolls of different speed ratios in an aqueous solution containing boric acid, to thereby obtain a polarizer (first polarizer). The obtained polarizer was laminated on a surface of the substrate film of the optical film A without the negative biaxial optical element formed. The polarizer was laminated such that a slow axis of the negative biaxial optical element and an absorption axis of the polarizer were substantially perpendicular to each other. Then, a commercially available TAC film (trade name “UZ-TAC”, available from Fuji Photo Film Co., Ltd.) having a thickness of 40 μm as a protective layer was laminated on a surface of the polarizer without the optical film A laminated, to thereby obtain a laminate B.

### REFERENCE EXAMPLE 3

### Production of Optical Compensation Layer

A commercially available polycarbonate film (available from Kaneka Corporation, trade name: R film, thickness of 65 μm) was stretched at a stretching temperature of 170° C. and a stretch ratio of 1.75 times by a fixed end stretching method, to thereby obtain a stretched film C having a thickness of 39 μm. This film was used as an optical compensation layer. The stretched film C had an in-plane retardation of 280 nm, a thickness direction retardation of 448 nm, and an Nz coefficient of 1.6.

### REFERENCE EXAMPLE 4

### Production of Optical Compensation Layer

A commercially available polycarbonate film (available from Kaneka Corporation, trade name: R film, thickness of 65 μm) was stretched at a stretching temperature of 155° C. and a stretch ratio of 1.15 times by a free end stretching method, to thereby obtain a stretched film D having a thickness of 60 μm. This film was used as an optical compensation layer. The stretched film D had an in-plane retardation of 280 nm, a thickness direction retardation of 336 nm, and an Nz coefficient of 1.2.

### REFERENCE EXAMPLE 5

### Production of Backlight Part

A commercially available linearly polarized light separation film (available from Sumitomo 3M, Ltd., trade name: DBEF) was attached to a light source part formed of a fluorescent lamp, a reflecting plate arranged in back of the fluorescent lamp, and a light scattering plate (opaque plate) arranged in front of the fluorescent lamp, to thereby produce a backlight part E.

### EXAMPLE 1

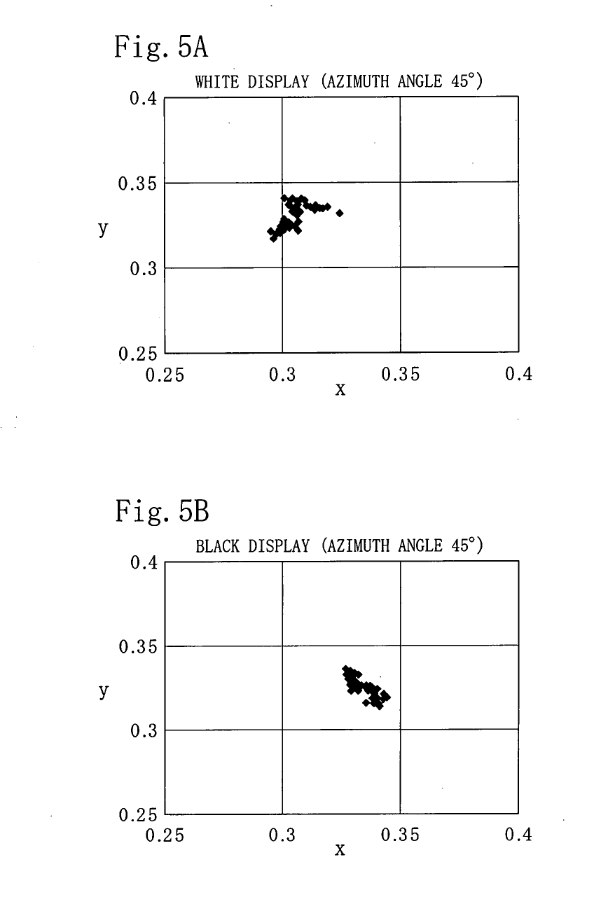

A liquid crystal cell was removed from a 26-inch liquid crystal television (trade name: Aquos) manufactured by Sharp Corporation and was used. The laminate B was attached to a backlight side of the liquid crystal cell through an acrylic pressure-sensitive adhesive (thickness of 20 μm) such that the TAC protective layer was arranged on an outer side (backlight side). Further, the optical compensation layer (stretched film) C was attached to an outer side of the TAC protective layer through an acrylic pressure-sensitive adhesive (thickness of 20 μm) such that an absorption axis of a polarizer (first polarizer) of the laminate B and a slow axis of the optical compensation layer were perpendicular to each other. Further, the backlight part E was attached to an outer side of the optical compensation layer. Meanwhile, a polarizing plate having a structure of polarizer/TAC protective film (available from Nitto Denko Corporation, trade name: HEG1425DU) was attached to a viewer side of the liquid crystal cell through an acrylic pressure-sensitive adhesive (thickness of 20 μm) such that the TAC protective layer was on an outer side (viewer side) and an absorption axis of a polarizer (first polarizer) on a backlight side and an absorption axis of a polarizer (second polarizer) on a viewer side were perpendicular to each other. In this way, a liquid crystal panel was produced. The hue and color shift of the obtained liquid crystal panel were measured. FIG. 5 shows measurement results of the color shift.

### EXAMPLE 2

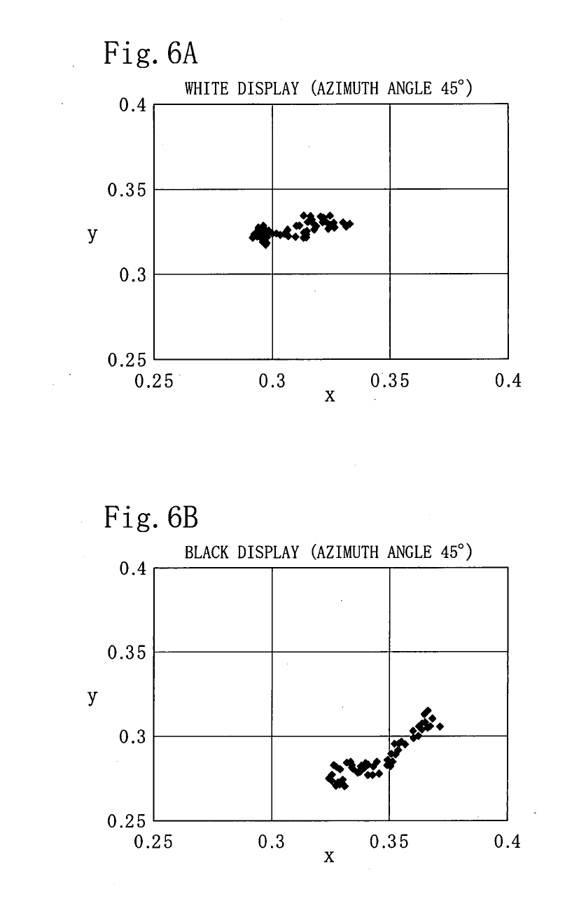

A liquid crystal panel was produced in the same manner as in Example 1 except that a 32-inch liquid crystal television (trade name: Aquos) manufactured by Sharp Corporation and the optical compensation layer (stretched film) D was used instead of the optical compensation layer (stretched film) C. The hue and color shift of the obtained liquid crystal panel were measured. FIG. 6 shows the measurement results of the color shift.

### EXAMPLE 3

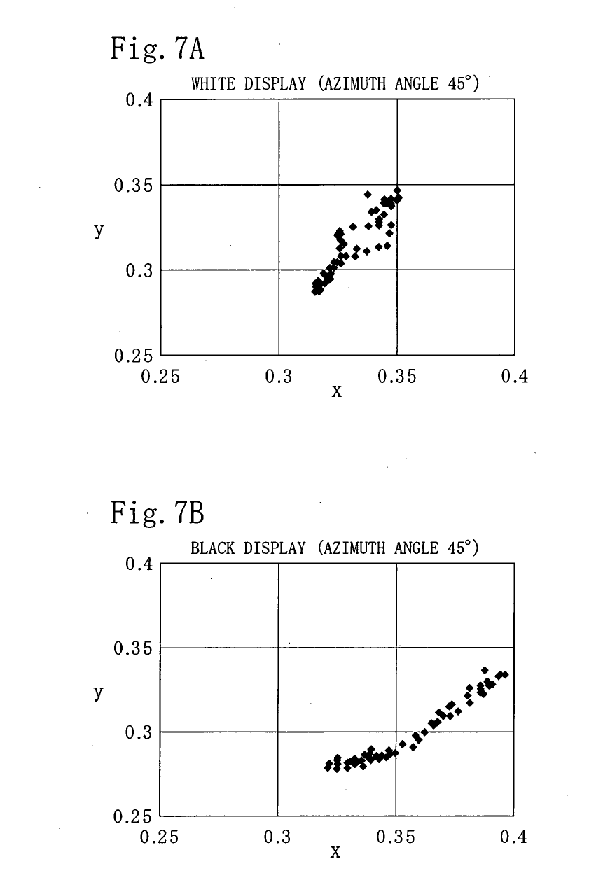

A liquid crystal panel was produced in the same manner as in Example 2 except that lamination was conducted such that the absorption axis of the first polarizer and the slow axis of the optical compensation layer were parallel to each other. The hue and color shift of the obtained liquid crystal panel were measured. FIG. 7 shows the measurement results of the color shift.

### COMPARATIVE EXAMPLE 1

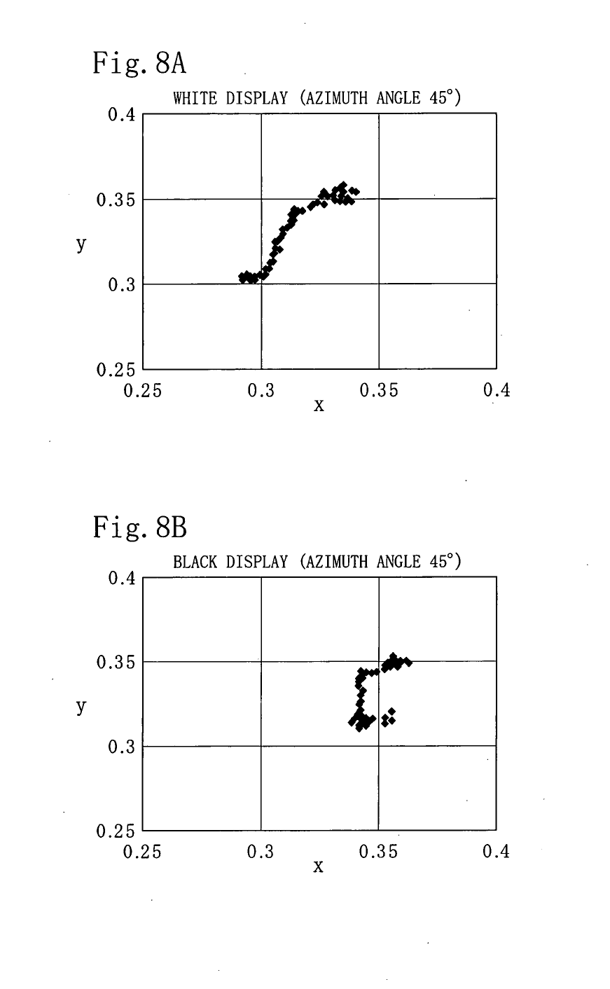

A liquid crystal panel was produced in the same manner as in Example 1 except that no optical compensation layer was provided. The hue and color shift of the obtained liquid crystal panel were measured. FIG. 8 shows the measurement results of the color shift.

### COMPARATIVE EXAMPLE 2

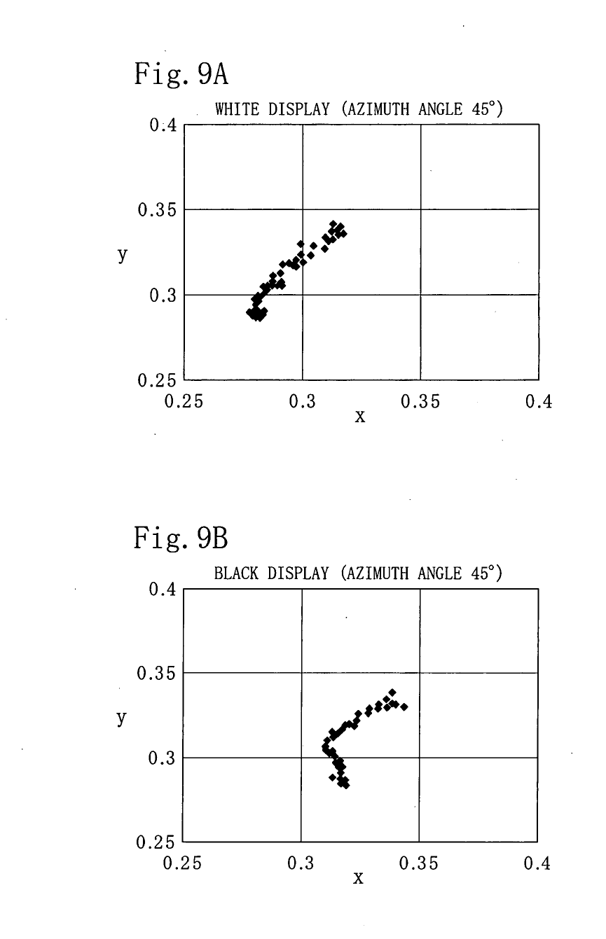

A liquid crystal panel was produced in the same manner as in Example 1 except that a backlight part having no linearly polarized light separation film was used. The hue and color shift of the obtained liquid crystal panel were measured. FIG. 9 shows the measurement results of the color shift.

FIGS. 5 to 9 reveal that the liquid crystal panel of each of Examples 1 to 3 had improved color shift compared with that of the liquid crystal panel of each of Comparative Examples 1 and 2. In particular, the liquid crystal panel of Example 1 had remarkably improved color shift. Further, in view of the hue in a frontal direction, the liquid crystal panel of each of Examples was hardly affected by the color of the backlight itself compared with that of the liquid crystal panel of each of Comparative Examples.

### INDUSTRIAL APPLICABILITY

The liquid crystal display apparatus of the present invention may suitably be used for a liquid crystal television, a cellular phone, or the like.

1. A liquid crystal panel, comprising a backlight part emitting polarized light, an optical compensation layer, a first polarizer, a liquid crystal cell, and a second polarizer in the stated order from a backlight side.

2. A liquid crystal panel according to claim 1, wherein the optical compensation layer has an Nz coefficient within a range of 1<Nz<3.

3. A liquid crystal panel according to claim 1, wherein the optical compensation layer comprises a stretched film of a polymer film containing as a main component cellulose ester or polycarbonate.

4. A liquid crystal panel according to claim 1, wherein the backlight part emitting polarized light comprises a light source part emitting natural light and a linearly polarized light separation film.

5. A liquid crystal panel according to claim 1, further comprising a negative biaxial optical element between the first polarizer and the liquid crystal cell and/or between the second polarizer and the liquid crystal cell.

6. A liquid crystal panel according to claim 5, wherein the negative biaxial optical element is formed of at least one non-liquid crystalline polymer material selected from polyamide, polyimide, polyester, polyether ketone, polyamideimide, and polyesterimide.

7. A liquid crystal panel according to claim 1, wherein a slow axis of the optical compensation layer and an absorption axis of the first polarizer are perpendicular to each other.

8. A liquid crystal panel according to claim 1, wherein the liquid crystal cell has drive mode selected from the group consisting of STN mode, TN mode, IPS mode, VA mode, OCB mode, HAN mode, and ASM mode.

9. A liquid crystal display apparatus, comprising the liquid crystal panel according to claim 1.

10. A liquid crystal panel according to claim 2, wherein the optical compensation layer comprises a stretched film of a polymer film containing as a main component cellulose ester or polycarbonate.

11. A liquid crystal panel according to claim 2, wherein the backlight part emitting polarized light comprises a light source part emitting natural light and a linearly polarized light separation film.

12. A liquid crystal panel according to claim 3, wherein the backlight part emitting polarized light comprises a light source part emitting natural light and a linearly polarized light separation film.

13. A liquid crystal panel according to claim 2, further comprising a negative biaxial optical element between the first polarizer and the liquid crystal cell and/or between the second polarizer and the liquid crystal cell.

14. A liquid crystal panel according to claim 3, further comprising a negative biaxial optical element between the first polarizer and the liquid crystal cell and/or between the second polarizer and the liquid crystal cell.

15. A liquid crystal panel according to claim 4, further comprising a negative biaxial optical element between the first polarizer and the liquid crystal cell and/or between the second polarizer and the liquid crystal cell.

16. A liquid crystal panel according to claim 13, wherein the negative biaxial optical element is formed of at least one non-liquid crystalline polymer material selected from polyamide, polyimide, polyester, polyether ketone, polyamideimide, and polyesterimide.

17. A liquid crystal panel according to claim 14, wherein the negative biaxial optical element is formed of at least one non-liquid crystalline polymer material selected from polyamide, polyimide, polyester, polyether ketone, polyamideimide, and polyesterimide.

18. A liquid crystal panel according to claim 15, wherein the negative biaxial optical element is formed of at least one non-liquid crystalline polymer material selected from polyamide, polyimide, polyester, polyether ketone, polyamideimide, and polyesterimide.

19. A liquid crystal panel according to claim 2, wherein a slow axis of the optical compensation layer and an absorption axis of the first polarizer are perpendicular to each other.

20. A liquid crystal panel according to claim 3, wherein a slow axis of the optical compensation layer and an absorption axis of the first polarizer are perpendicular to each other.
